(19) United States
(12) Patent Application Publication
(10) Pub. No.: US 2007/0055616 A1
(43) Pub. Date: Mar. 8, 2007

(54) ENHANCED ONLINE AUCTION METHOD APPARATUS AND SYSTEM

(76) Inventors: Danny Clay, Springville, UT (US); Steven F. McDaniel, Provo, UT (US); Morgan B. Adair, Lindon, UT (US)

Correspondence Address: UTAH VALLEY PATENT SERVICES, LLC, 846 S. 1350 E., PROVO, UT, 84606, US

(21) Appl. No.: 11/558,901

(22) Filed: Nov. 11, 2006

Related U.S. Application Data
(63) Continuation-in-part of application No. 10/993,330, filed on Nov. 19, 2004.
Application No. 10/993,330 is a continuation of application No. 10/965,646, filed on Oct. 14, 2004.
(60) Provisional application No. 60/529,506, filed on Dec. 15, 2003.

(51) Int. Cl. G06Q 40/00

(52) U.S. Cl. 705/37

(57) ABSTRACT

An enhanced online auction system facilitates auction buyers listing items wanted for purchase. Users such as traders may use the auction system to search the item-wanted listings, the item-available listings, or both. Item-available listings may be offered for immediate-sale, auction, or best-offer sale. Item-wanted listings may be solicited for immediate-purchase, reverse-auction, or best-offer purchase. Item-available listings and item-wanted listings may be generated by using an existing listing as a template. All sale and purchase offers may incorporate time-dependent pricing. Auction traders may list a product line or set of item-wanted listings in a hierarchical structure. Fulfillment proposals facilitate auction sellers satisfying a set of item-wanted listings from one or more buyers. Item-available listings and item-wanted listings may be linked or cross-linked by auction traders or automatically by auction system processes.

### CROSS-REFERENCES TO RELATED APPLICATIONS

This application is a continuation-in-part and claims the benefit of U.S. patent application Ser. No. 10/993,330 entitled “ENHANCED ONLINE AUCTION METHOD APPARATUS AND SYSTEM” and filed on Nov. 19, 2004 for Danny Clay, Steven F. McDaniel, and Morgan B. Adair, which is a continuation of U.S. patent application Ser. No. 10/965,646 entitled “ENHANCED ONLINE AUCTION METHOD AND APPARATUS” and filed on Oct. 14, 2004 for Danny Clay, which claims priority to U.S. Provisional Patent Application No. 60/529,506 entitled “ENHANCED ONLINE AUCTION METHOD APPARATUS AND SYSTEM” and filed on Dec. 15, 2003 for Danny Clay, Steven F. McDaniel, and Morgan B. Adair.

### BACKGROUND OF THE INVENTION

1. Field of the Invention

The present invention relates to auctioning items for sale on an internetwork. Specifically, the invention relates to apparatus, methods, and systems for online auction trading.

2. Description of the Related Art

FIG. 1 is a schematic diagram depicting a prior art online auction trading system 100. The prior art online auction trading system 100 includes one or more auction web servers 110, an auction database 115 that may include a plurality of database replicas or partitions 115a and 115b, an internetwork 120, seller workstations 130, seller data stores 135, and buyer workstations 140. The prior art online trading system 100 facilitates sellers of merchandise and services to post items for auction, and buyers to search or browse for items available for sale.

While the online auction trading system 100 enables certain transactions between auction buyers and sellers it does not provide means for buyers to post item-wanted listings, or for sellers to search for items that auction buyers want to purchase. Furthermore, the auction database is organized as a collection of sale items, and does not enable traders to organize sale items and item-wanted listings into a hierarchical structure corresponding to a product line or aggregate item-wanted listings into a set of related fulfillment requests.

FIG. 2 is a block diagram depicting a typical prior art search interface 200. The prior art search interface 200 includes a search dialog 210, search dialog tabs 220, a search keyword text field 230, search parameter interface elements 240, search results interface elements 250, a search initiation interface element 260, a search results page 270, a search options display 280, and a search results listing 290.

The prior art search interface 200 provide a basic user interface for searching an auction database for items that sellers have offered for sale. However, the prior art search interface 200 does not provide for item-wanted listings or facilitate auction sellers searching for item-wanted listings.

Accordingly, what is needed is an enhanced online auction system that expedites auction buyers creating item-wanted listings, facilitates auction sellers searching item-wanted listings, and enables auction traders to organize sale items and item-wanted listings into a hierarchical structure and aggregate multiple item-wanted listings into an aggregate fulfillment request.

### BRIEF SUMMARY OF THE INVENTION

The present invention has been developed in response to the present state of the art, and in particular, in response to the problems and needs in the art that have not yet been fully solved by currently available online auction systems. Accordingly, the present invention has been developed to provide an improved online auction apparatus, method, and system that overcome many or all of the above-discussed shortcomings in the art.

In one aspect of the present invention, a system for facilitating online commerce facilitates posting items wanted for purchase in addition to items offered for sale. Items offered for sale may be auction items, immediate-sale items, or best-offer items. Items wanted for purchase may be immediate-purchase items, reverse-auction items, or best-offer items. In one embodiment, all sale and purchase offers may incorporate time-dependent pricing.

In another aspect of the present invention, a method for facilitating online commerce facilitates traders using an auction system to search for item-wanted listings, item-available listings, or both. Item-available listings or item-wanted listings may be posted by using an existing auction listing as a template.

In another aspect of the present invention, a method for facilitating marketing of a product line facilitates organizing product line listings into a hierarchical structure. In certain embodiments, users may post item-wanted listings within the hierarchical structure. For example, a user may post an item-wanted listing within a seller's product line for an item that is not in stock, or for an item which the user wishes the seller to begin offering for sale.

In another aspect of the present invention, a method for facilitating purchase fulfillment enables auction traders organize groups of item-wanted listings in a hierarchical structure. Fulfillment proposals facilitate auction sellers satisfying a set of item-wanted listings for one or more auction buyers.

In another aspect of the present invention, a method for linking listings facilitates linking or cross-linking item-available listings and item-wanted listings either manually by auction traders or automatically by auction system processes.

The present invention facilitates a variety of sale and purchase models for auction traders including but not limited to: buyers and sellers of individual items, manufacturers and sellers of a product line, system integrators, and commodity traders. These and other features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram illustrating a typical prior art system for conducting an online auction;

FIG. 2 is a block diagram illustrating a typical prior art search interface for entering auction search parameters and displaying search results;

FIGS. 3A, 3B, and 3C are block diagrams illustrating several embodiments of an enhanced search interface of the present invention;

FIG. 4 is a flow chart diagram depicting one embodiment of a online trading method of the present invention;

FIG. 5 is a schematic illustration depicting one embodiment of a posting dialog of the present invention;

FIG. 6 is a flow chart diagram depicting one embodiment of a browsing method of the present invention;

FIG. 7 is a flow chart diagram illustrating one embodiment of an enhanced search method of the present invention;

FIG. 8 is a flow chart diagram illustrating one embodiment of a user interface method of the present invention;

FIG. 9 is a flow chart diagram illustrating one embodiment of a customer request method of the present invention;

FIG. 10 is a flow chart diagram illustrating one embodiment of a proposal fulfillment method of the present invention;

FIG. 11A is a flow chart diagram illustrating one embodiment of an item-wanted search method of the present invention;

FIG. 11B is a flow chart diagram illustrating one embodiment of an auction item search method of the present invention;

FIG. 12 is a flow chart diagram illustrating one embodiment of an item-wanted solicitation method of the present invention;

FIG. 13 is a flow chart diagram illustrating one embodiment of an item-available solicitation method of the present invention;

FIG. 14 is a flow chart diagram illustrating one embodiment of an item-available to item-wanted link method of the present invention;

FIG. 15 is a flow chart diagram illustrating one embodiment of an item-wanted to item-available link method of the present invention;

FIG. 16 is a block diagram illustrating one embodiment of an item-wanted initial dialog of the present invention;

FIG. 17 is a block diagram illustrating one embodiment of an item-wanted listing dialog apparatus of the present invention;

FIG. 18 is a block diagram illustrating one embodiment of a selected category search dialog of the present invention;

FIG. 19 is a block diagram illustrating one embodiment of an item-wanted listing of the present invention;

FIG. 20 is block diagram illustrating one embodiment of a response dialog of the present invention

### DETAILED DESCRIPTION OF THE INVENTION

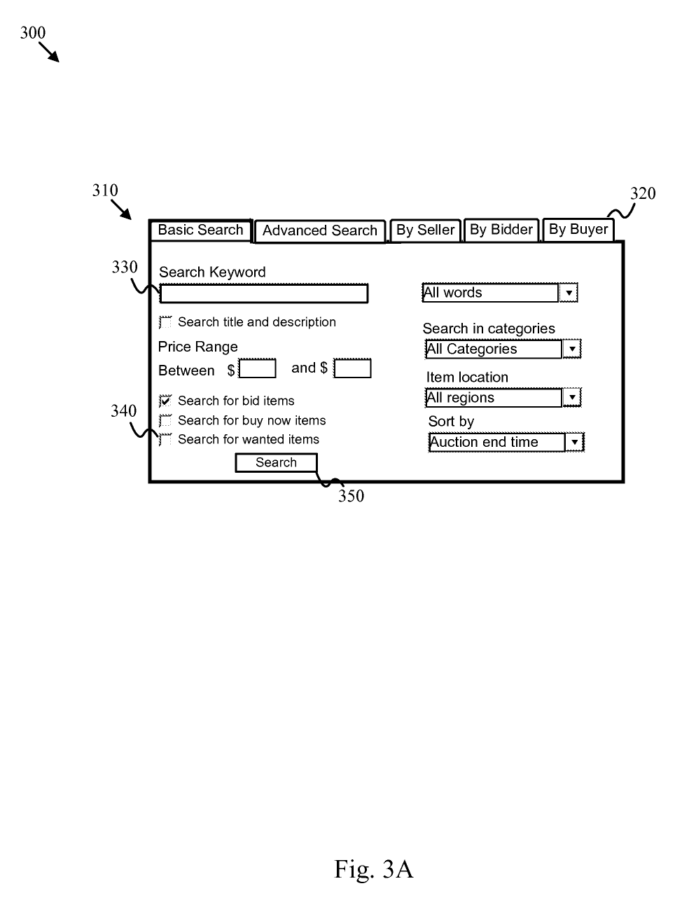

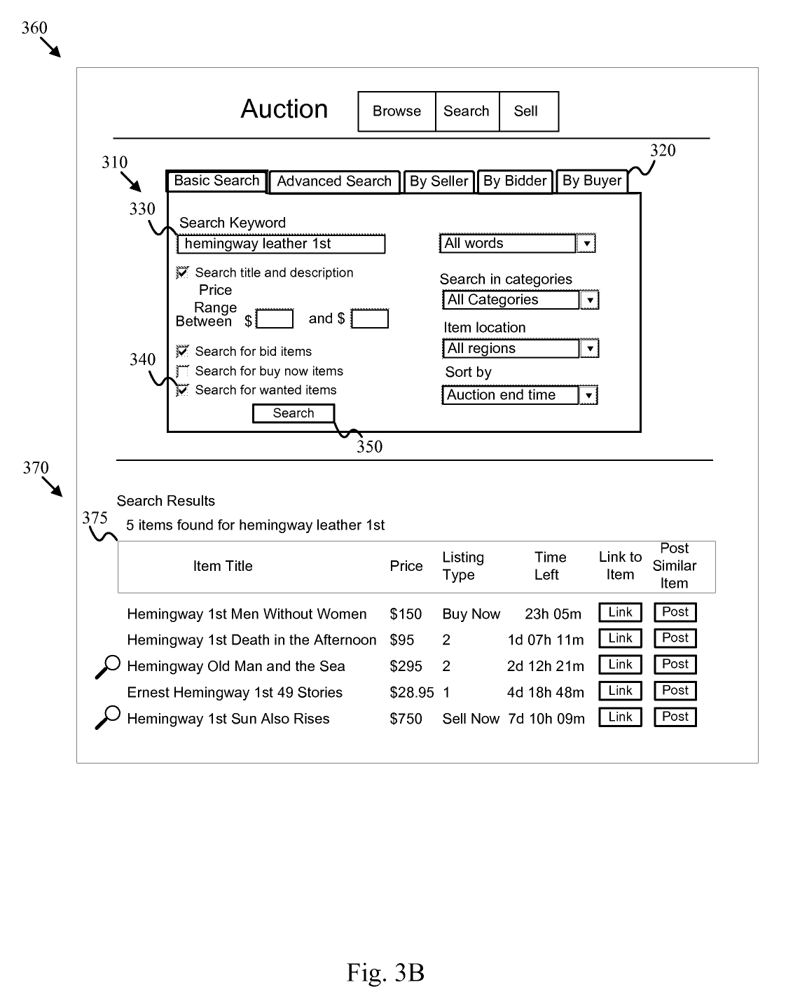

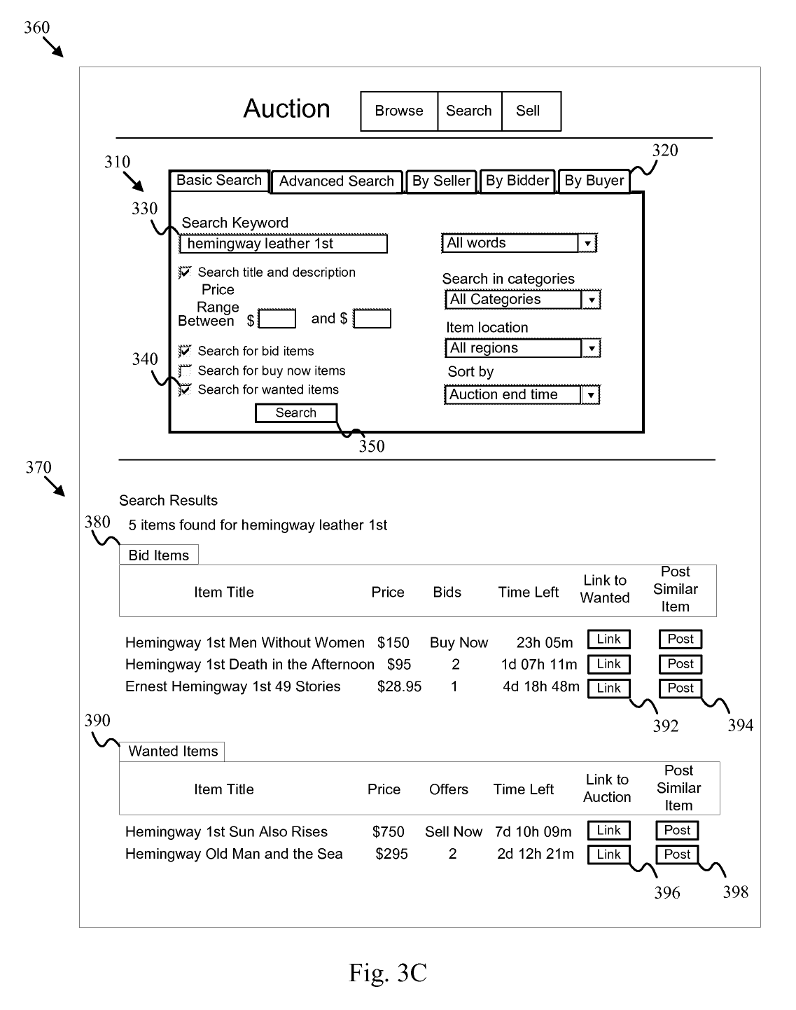

It will be readily understood that the components of the present invention, as generally described and illustrated in the Figures herein, may be arranged and designed in a wide variety of different configurations. Thus, the following more detailed description of the embodiments of the apparatus, method, and system of the present invention, as represented in FIGS. 3 through 20, is not intended to limit the scope of the invention, as claimed, but is merely representative of selected embodiments of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment and the described features, structures, or characteristics may be combined in any suitable manner in one or more embodiments

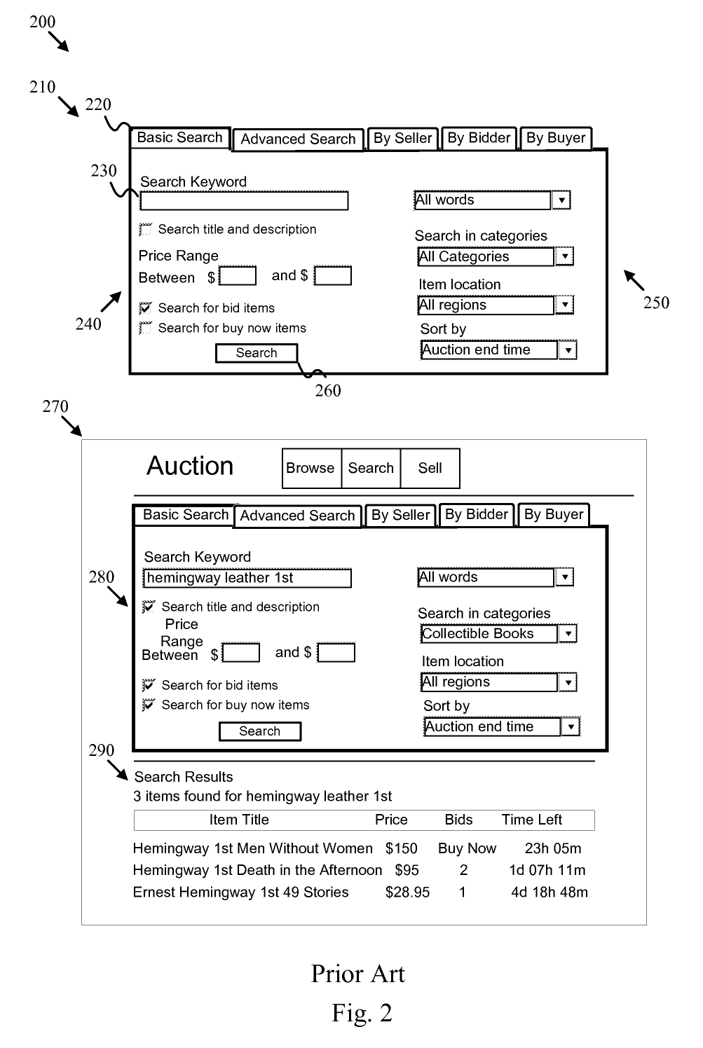

FIG. 3A is a block diagram illustrating one embodiment of a search interface 300 of the present invention. The depicted search interface 300 includes a search dialog 310, a search ‘By Buyer’ tab 320, a search keyword text field 330, a search for wanted items checkbox 340, and a search control 350. The search interface 300 provides enhanced auction features to auction buyers and sellers beyond those provided by the prior art search dialog 210 shown in FIG. 2.

The depicted search dialog 310 may contain all of the search dialog components of the prior art search dialog 210. The depicted search dialog 310 facilitates a user searching the auction database 115 for item-wanted listings by entering keywords into the search keyword text field 330, checking the search for wanted items checkbox 340, and clicking the search control 350. The search ‘By Buyer’ tab 320 facilitates searching the auction database 115 for item-wanted listings by entering the user name or identification number of the buyer who posted the item-wanted listing.

In the depicted embodiment, a search for a wanted-item listing is performed by checking the search for wanted items checkbox 340. In certain embodiments, item-wanted listings may be identified in the auction database 115 by a unique sequence of characters in the item description. For example, item-wanted listing descriptions may begin with the characters “*ISO” to identify the listing as an item the potential buyer is “in search of.”

By facilitating searches for item-wanted listings, the search interface 300 expedites transactions between auction sellers and potential buyers. Auction sellers may search item-wanted listings to measure demand for items the seller may offer for sale, to estimate the market price of wanted items, to identify new products the seller may be able to sell profitably, to identify product features desired by potential purchasers, or to identify potential purchasers that may be contacted when a wanted item is listed for sale.

FIGS. 3B and 3C are text-based diagrams depicting two alternate embodiments of an auction search and search results web page 360a and 360b of the present invention. The auction search and search results web page 360 may include all of the components of the auction search page 300. In addition, the search results web page 360 may include a search results listing 370, an auction items list 380, a wanted items list 390, one or more ‘link to wanted item’ controls 392, one or more ‘post similar auction item’ controls 394, one or more ‘link to auction item’ controls 396, and one or more ‘post similar wanted item’ controls 398.

The search results listing 370 displays a list of items found in a search of the auction database 115. The search results listing 370 may include auction items and wanted items, as specified by search parameters entered in the search dialog 310 by the auction trader.

The auction items list 380 contains a list of auction items returned by a search of the auction database 115. The auction items list 380 may include fields such as the auction item title, the current bid price, if any, the number of bids, and the time remaining in the auction. In the depicted embodiment, the ‘link to wanted item’ controls 392 and the ‘post similar auction item’ controls 394 are associated with each item in the auction items list 380. The ‘link to wanted item’ controls 392 facilitate the auction trader establishing a link in the auction database 115 between an auction item and a similar wanted item listing. The ‘link to wanted item’ controls 392 may also appear on a display containing a detailed description of an auction listing. The ‘post similar auction item’ controls 394 facilitate an auction trader listing an auction item listing based on an existing auction item listing that was returned by a search of the auction database 115. Listing an auction item based on an existing listing facilitates an auction trader listing items for sale without having to enter data for all fields describing the item.

The wanted items list 390 contains a list of wanted items returned by a search of the auction database 115. The wanted items list 390 may include fields such as the auction item title, the current offering price, if any, the number of offers, and the time remaining in the auction. In the embodiment depicted, a ‘link to auction item’ control 396 and a ‘post similar wanted item’ control 398 is associated with each item in the wanted items list 390. The ‘link to auction item’ control 396 facilitates the auction trader establishing a link in the auction database 115 between an item-wanted listing and a similar auction item listing. The ‘link to auction item’ control 396 may also appear on a display containing a detailed description of an item-wanted listing. The post similar wanted item controls 398 facilitates listing an item-wanted listing based on an existing item-wanted listing that was returned by a search of the auction database 115. Listing an item-wanted listing based on an existing listing facilitates creating an item-wanted listing without entering data in all fields describing the item.

In some embodiments, the wanted items list 390 may identify the potential buyer listing the item-wanted listing. In other embodiments, the wanted items list 390 may display item-wanted listings anonymously. Anonymous display of items-wanted listings promotes communication of potential buyer demand to auction sellers without providing a means for contact between auction sellers and potential buyers outside the auction system. In this way, anonymous display of items-wanted listings helps protect the profitability of the auction system. In some embodiments, the wanted items list 390 may include a mechanism for allowing auction sellers to notify anonymous creators of item-wanted listings when an item possibly matching an item-wanted listing is listed for sale.

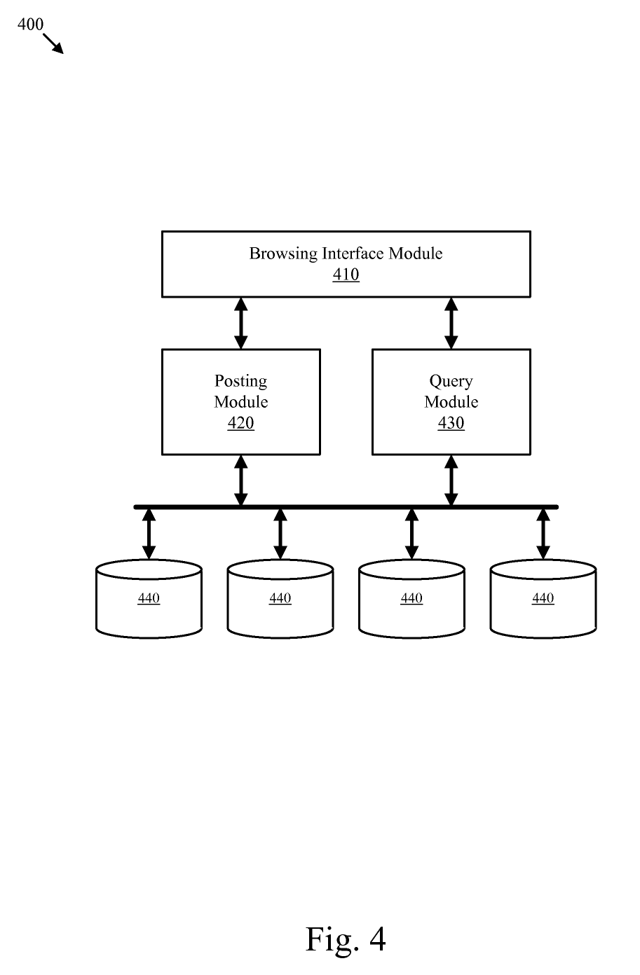

FIG. 4 illustrates one embodiment of a commerce server 400 of the present invention. The commerce server 400 includes a browsing interface module 410, a posting module 420, a query module 430, and one or more data stores 440 which in one embodiment is a database. The commerce server 400 enables a user to search the data stores 440 for items offered-for-sale, and items wanted-for-purchase. The user may also submit postings to the data stores 440 corresponding to items offered-for-sale and items wanted-for-purchase. The user may constitute a buyer, a seller, a trader, an agent, or the like.

In certain embodiments, the browsing interface module 410 (or alternately user interface module 410) enables a user equipped with a standard browser to conduct commerce-related operations relative to postings stored on the data stores 440. In one embodiment, the browsing interface module 410 serves web pages for generating postings, conducting searches, viewing listings, and conducting transactions.

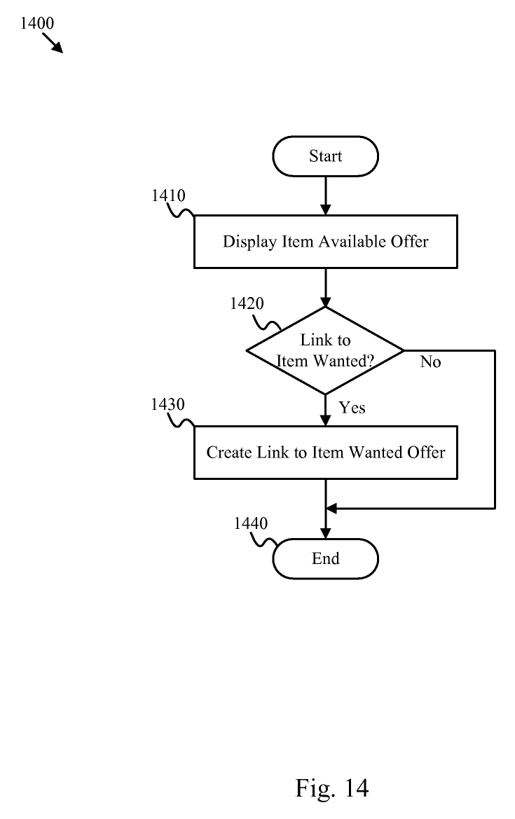

The posting module 420 receives posting information from the browsing interface module 410 and provides such information to the data stores 440. In one embodiment, the posting module is configured to interface with a database residing on the data stores 440. The posting module 420 may also link postings for offered-for-sale and wanted-for-purchase items within the database in response to a user initiated request from the interface module 410 (see for example the description of the controls 392 and the description of similar means and methods shown in FIGS. 14-20).

The postings may correspond to items offered-for-sale and items wanted-for-purchase. Postings for items offered-for-sale may include auction postings, immediate-sale postings, and best-offer postings. Auction postings are used to enable a bidding process such as the highest bidder within a specified time period. Immediate-sale postings enable the first buyer that agrees to certain terms to purchase the item offered-for-sale. Best offer postings enable a seller to select the most attractive offer or trade from a set of offers or trades based on additional factors other than price.

Postings for items wanted-for-purchase may include reverse-auction postings, immediate-purchase postings, and best-offer postings. Reverse-auction postings enable a reverse bidding process such as multiple sellers competing to provide an item wanted-for-purchase at the best price. Immediate-purchase postings enable the first seller that agrees to certain terms to sell the item wanted-for-purchase. A best offer posting for an item wanted-for-purchase enables a buyer to select the most attractive offer or trade from a set of offers or trades based on additional factors other than price.

In certain embodiments, one or more users may be automatically notified when a posting for an item offered-for-sale matches a wanted-item posting. Automatic notification facilitates deferred pairing of buyers and sellers and informs users of opportunities without requiring diligent monitoring of the auction system.

The query module 430 finds postings stored within the data stores 440 that match selected criteria. In the depicted embodiment, the query module 430 receives the selected criteria from the browsing interface module and initiates a search of the data stores 440 for postings matching the selected criteria.

The query module 430 may provide search results in the form of listings to the browsing interface module which may format the listings for viewing. In certain embodiments, wanted-for-purchase listings are marked with an item-wanted mark in order to distinguish them from offered-for-sale listings. Examples of item-wanted marks include a label, an icon, a magnifying glass, a spyglass, a telescope, a missing poster, and a wanted poster. Certain labels may be acronyms such as ‘ISO’ (“in search of”), ‘WTB’ (“wanted to buy”), or ‘GHI’ (“gotta have it”), or the like.

In addition to postings and listings related to items offered-for-sale, the commerce server 400 supports postings and listings for items wanted-for-purchase. Hence, sellers and auction traders may benefit from knowing what potential buyers are in need of and buyers have an avenue to purchase items that are not currently offered for sale.

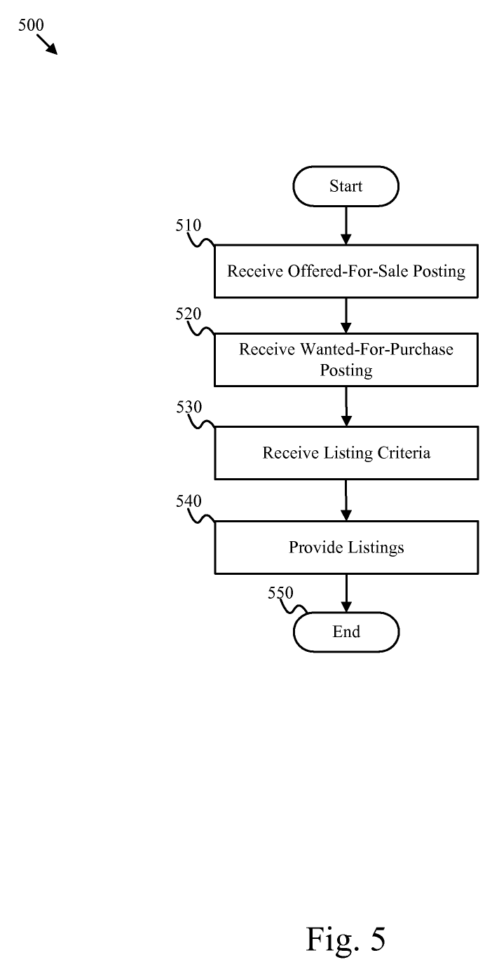

FIG. 5 is a flow chart diagram depicting one embodiment of an online trading method 500. The online trading method 500 includes a receive offered-for-sale posting step 510, a receive wanted-for-purchase posting step 520, a receive listing criteria step 530, and a provide listings step 540. The method 500 enables an online auction site to provide a double service that permits a user to post a listing for both items offered-for-sale and for items wanted-for-purchase and also permits the user to query both types of postings.

Referring now to FIGS. 4 and 5, in one embodiment, the method 500 begins and the posting module 420 receives 510 one or more postings for an item offered-for-sale. The posting module 420 may also receive 520 one or more postings for an item wanted-for-purchase. One or more users may post both types of postings through the browsing interface 410. The postings may be stored within a data store 440.

Subsequently, the query module 430 may receive 530 listing criteria from a user through the browsing interface 410. The listing criteria may determine the types of postings the user prefers to view. The query module 430 may search the data stores 440 for the specific postings and then may provide 540 the listings that match the selected criteria to the user through the browser interface 410. Providing 540 the listings may comprise serving at least one web page. Subsequently the method 500 ends 550.

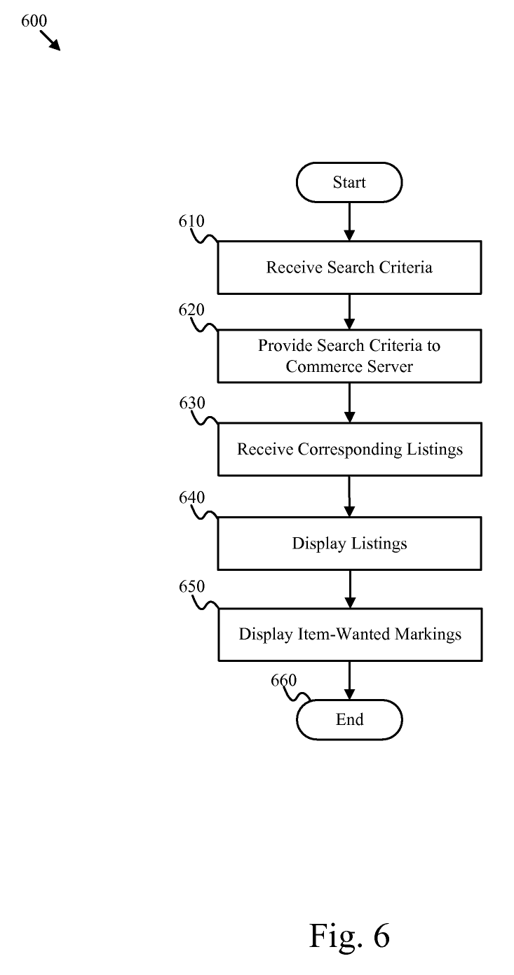

FIG. 6 is a flow chart diagram depicting one embodiment of a browsing method 600 of the present invention. The depicted browsing method 600 includes receiving 610 listing criteria, providing 620 the listing criteria to a commerce server, receiving 630 corresponding listings, displaying 640 the listings, and displaying 650 item-wanted markings. The method 600 enables one or more users to search a data store 440 for postings that correspond to selected criteria.

The browsing method 600 begins by receiving 610 the listing criteria. The listing criteria may include receiving any type of criteria useful for navigating or finding postings and need not be associated with a search operation. For example, the listing criteria may correspond to specific links activated by the user. Alternately, the listing criteria may correspond keywords entered into a search dialog.

The method continues by providing 620 the listing criteria to a commerce server such as the commerce server 400. Subsequently, the listings corresponding to the selected criteria are then received 630, and displayed 640. The listings corresponding to item-wanted postings may be displayed 650 with an item-wanted mark or symbol.

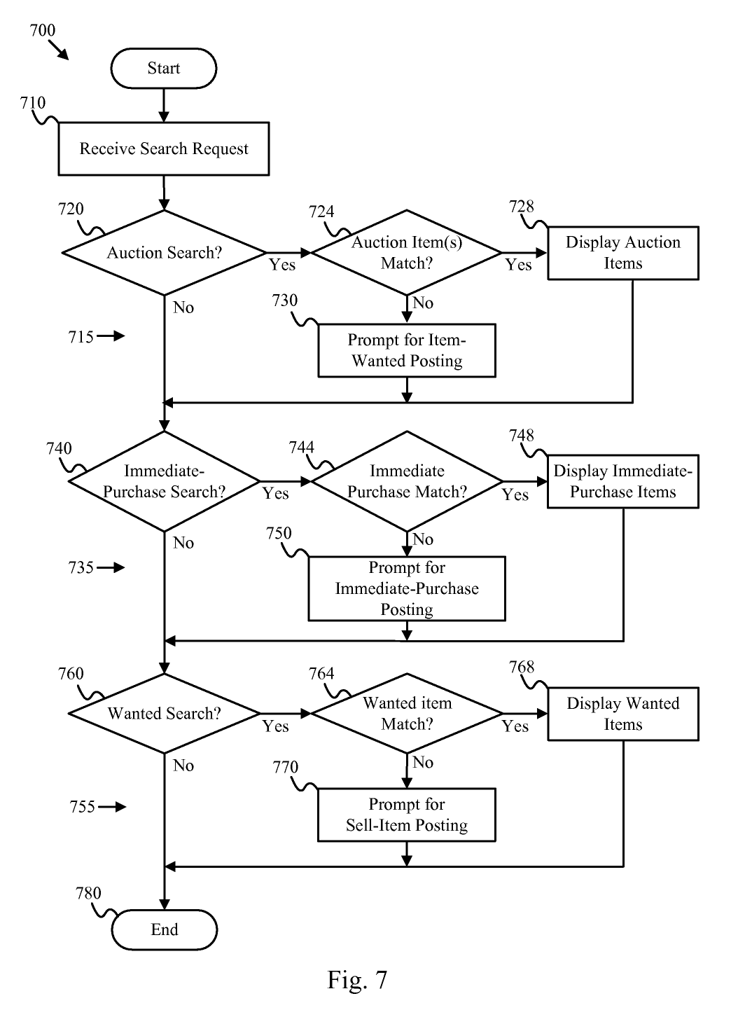

FIG. 7 is a flow chart diagram illustrating one embodiment of an enhanced auction search method 700 of the present invention. The depicted enhanced auction search method 700 includes processing branches 715, 735, and 755 that respectively correspond to searching for auction items, searching for immediate-purchase items, and searching for wanted items. In certain embodiments, the enhanced auction search method 700 prompts a user with an option to post a listing if no listings are found that match the search criteria provided by the user.

The depicted method begins by receiving 710 a request to conduct a search. In one embodiment, receiving 710 a request to conduct a search corresponds to a user filling out a search dialog such as the search dialog 310 depicted in FIG. 3A. In response to receiving 710 the search request, the depicted method 700 proceeds sequentially or concurrently through the processing branches 715, 735, and 755.

The processing branch 715 relates to searching for auction items and begins by testing 720 whether the search as specified by the user includes searching for auction items. If the specified search does not include searching auction items, the processing branch 715 is aborted. If the specified search includes searching for auction items the method proceeds by testing 724 whether the database contains one or more auction items that match the search criteria.

If the one or more auction items that match the search criteria are found, the method 700 continues by displaying 728 a listing of the auction items to the user. However, if no auction items are found that match the search criteria, the method continues by prompting 750 the user with an option to create an item-wanted listing. In one embodiment, prompting 750 includes displaying a pop-up dialog. In another embodiment, prompting includes displaying a link to a listing page.

In the depicted embodiment, the processing branch related to immediate-purchase items includes an immediate-purchase search test 740, an immediate-purchase match test 744, a display immediate-purchase items step 748, and a prompt for immediate-purchase listing step 750.

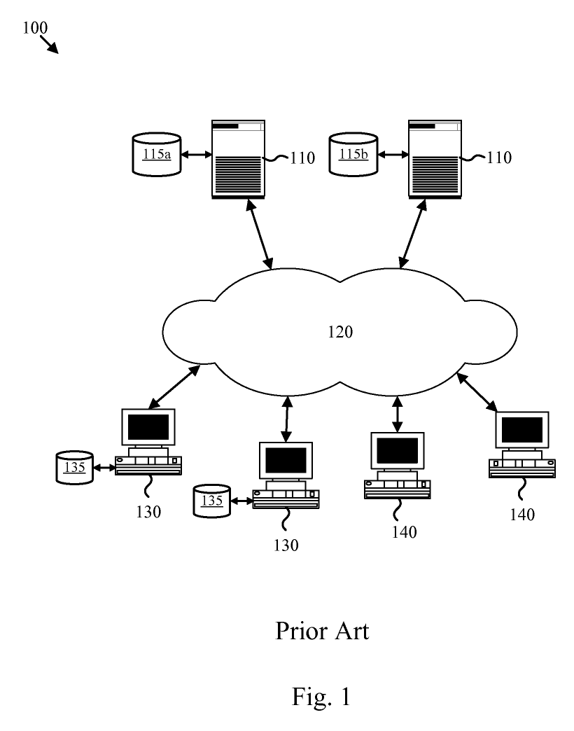

In the depicted embodiment, the processing branch related to wanted items includes a wanted items search test 760, a wanted item match test 764, a display wanted items step 768, and a prompt for sell-item listing 770. The enhanced auction search method 700 is used in accordance with the auction search and search results pages 300 shown in FIG. 3A, and the auction database 115 shown in FIG. 1. The enhanced auction search method 700, in addition to the search capabilities provided in prior art, facilitates searching the auction for wanted items that have been posted by auction buyers.

The receive request step 710 receives a request to search the auction database 115 from an auction trader utilizing the search dialog 310 or the like. The auction web server 210 receives search parameters entered by the auction trader and initiates a search of the auction database 115.

The auction items requested test 720, determines whether the auction trader is searching the auction database 115 for items posted for auction. If the trader is searching for auction items, the auction search method 700 continues with matching auction items test 724, otherwise the auction search method 700 continues with the immediate-purchase items requested test 740.

The matching auction items test 724, determines whether the auction database 115 contains auction items matching the parameters received from the auction trader in the receive search request step 710. If there are matching items, the auction search method 700 continues with the display auction items step 728, otherwise the auction search method 700 continues with the display items wanted element step 730.

The display auction items step 728 displays the results of the matching auction items test 724 using the search results listing 370. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display auction items wanted element step 730 provides an auction trader with the option of listing an auction item-wanted listing by displaying a user interface element such as a control, dialog, icon, hyperlink, or the like. The item-wanted element may be linked to a data entry page, a form, a dialog, a wizard, or the like.

The immediate-purchase items requested test 740 determines whether the auction trader has initiated a search for items available for immediate-purchase. If the trader is searching for immediate-purchase items, the auction search method 700 continues with the matching immediate-purchase items test 744, otherwise the auction search method 700 continues with the wanted items requested test 760.

The matching immediate-purchase items test 744 determines whether the auction database 115 contains immediate-purchase items matching the parameters received from the auction trader in the receive search request step 710. If there are matching items, the auction search method 700 continues with the display immediate-purchase items step 748, otherwise the auction search method 700 continues with the display items wanted element step 750.

The display immediate-purchase items step 748 displays the results of the matching immediate-purchase items test 744 using the search results listing 370. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display immediate-purchase items wanted element step 750 provides an auction trader with the option of listing an immediate-purchase item-wanted listing by displaying a user interface element such as a control, dialog, icon, hyperlink, or the like. The item-wanted element may be linked to a data entry page, a form, a dialog, a wizard, or the like.

The wanted items requested test 760 determines whether the auction trader has initiated a search for wanted items. If the trader is searching for wanted items, the auction search method 700 continues with the matching wanted items test 764, otherwise the auction search method ends 780.

The matching wanted items test 764 determines whether the auction database 115 contains wanted items matching the parameters received from the auction trader in the receive search request step 710. If there are matching items, the auction search method 700 continues with the display wanted items step 768, otherwise the auction search method 700 continues with the display sell item element step 770.

The display wanted items step 768 displays the results of the matching wanted items test 764 using the search results listing 370. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display sell item element step 770 provides an auction trader with the option of listing a new item listing for an auction or immediate-sale item by displaying a user interface element such as a control, dialog, icon, hyperlink, or the like. The item-wanted element may be linked to a data entry page, form, a dialog, a wizard, or the like.

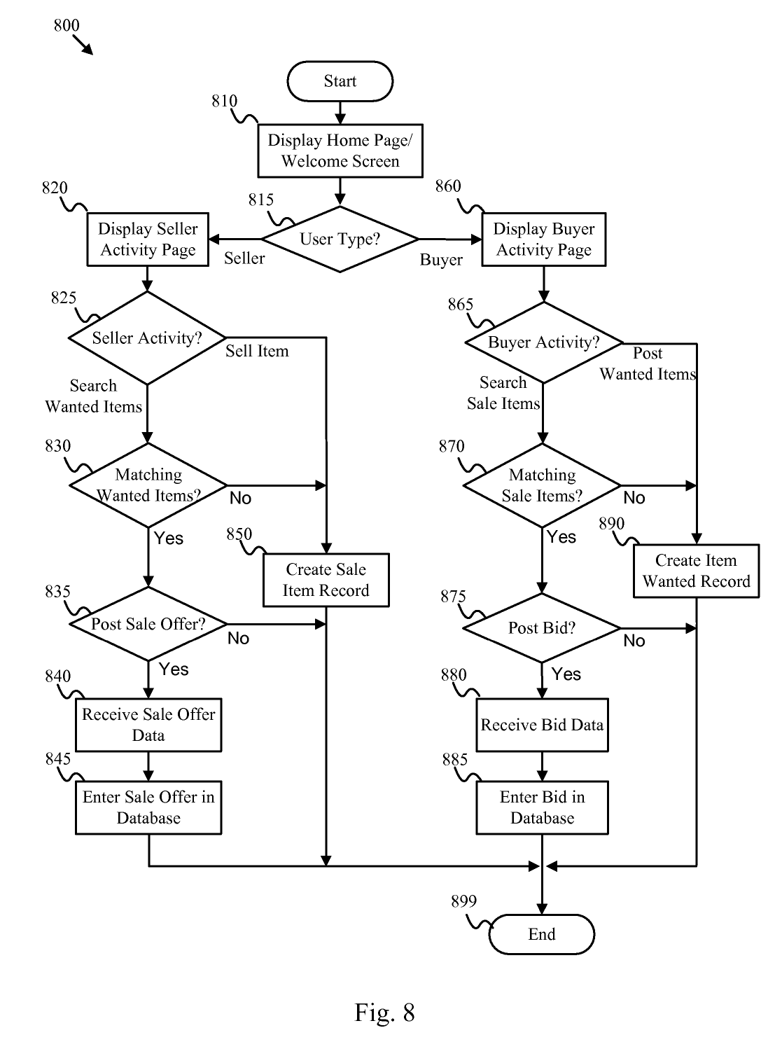

FIG. 8 is a flow chart diagram illustrating one embodiment of a user interface method 800 of the present invention. The user interface method 800 includes a display home page step 810, a user type test 815, a display seller page step 820, a seller activity test 825, a matching wanted items test 830, a post sale offer test 835, a receive offer data step 840, an enter offer in database step 845, a create sale item record step 850, a display buyer page step 860, a buyer activity test 865, a matching sale items test 870, a post bid test 875, a receive bid data step 880, an enter bid data in database step 885, and a create item-wanted record step 890. The user interface method 800 obtains database search parameters from auction traders, presents results of database searches, provides auction traders with the option to create new sale item and item-wanted listings, and provides auction traders with the option to post sale offers and bids.

The display home page step 810 provides user interface elements that introduce auction traders to the highest level operations of the auction system. Operations may be accessed using user interface elements such as menus, tabs, lists, icons, or the like. The display home page step 810 typically provides basic instructions to auction traders in the use of the auction system and links to detailed instructions, frequently asked questions about the auction system, an auction trader registration page, an auction trader login page, and the like.

The user type test 815 determines whether the auction trader accessing the auction system is operating as a buyer or seller. If the auction trader is acting as a seller, the user interface method 800 continues with the display seller activity page step 820. If the auction trader is acting as a buyer, the user interface method 800 continues with the display buyer activity page step 860. Auction traders may act in either role at various times, and in some embodiments the user interface method 800 provides operations associated with both roles to all auction traders.

The display seller page step 820 provides user interface elements that facilitate auction sellers selling items using the auction system and search the auction database 115 for wanted item records. In some embodiments, the display seller page step 820 includes registering the auction trader or logging the auction trader into the auction system.

The seller activity test 825 determines whether the auction seller is searching the auction database 115 for wanted item records or selling items. If the auction seller is searching the auction database 115 for wanted item records, the user interface method 800 continues with the matching wanted items test 830. If the auction seller is selling items, the user interface method 800 continues with the create sale item record step 850.

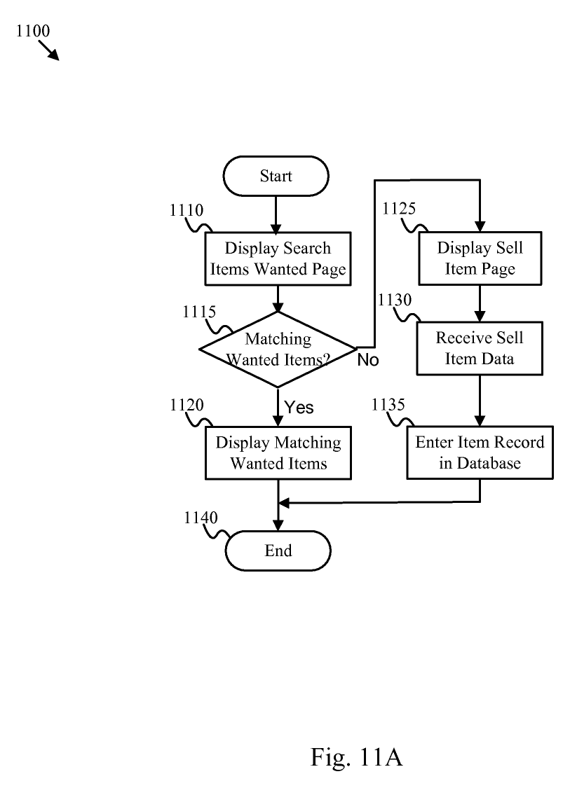

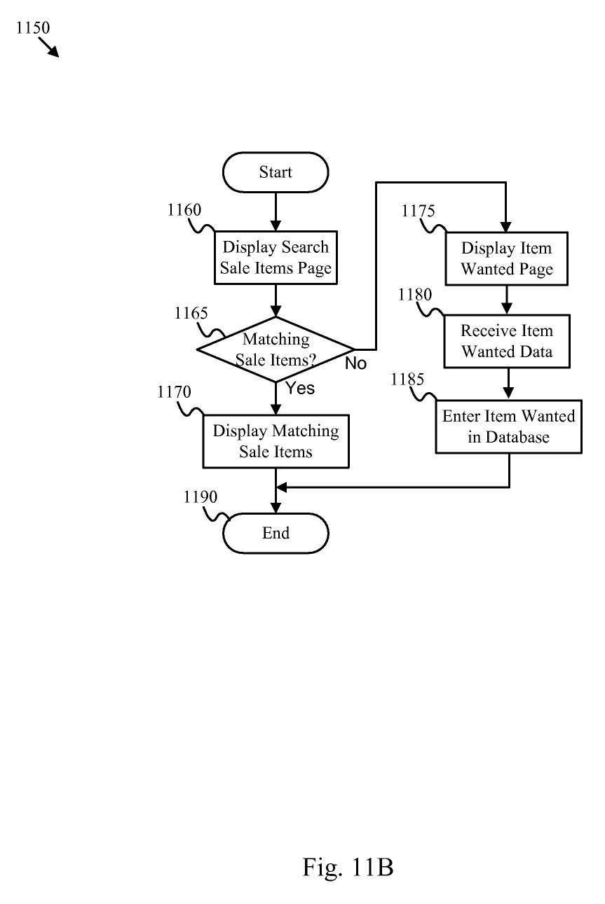

The matching wanted items test 830 obtains search parameters from the auction seller, searches the auction database 115 for records matching the search parameters, and presents the search results to the auction seller. Search results may be presented as a list of wanted item titles with links to pages with a detailed display of data associated with the wanted item. FIG. 11A is a flow chart diagram with the steps of an embodiment of the matching wanted items test 830 and create sale item record step 850 in greater detail. If the auction database 115 contains records that match the search parameters entered by the auction seller, the user interface method 800 continues with the post sale offer test 835, otherwise the user interface method 800 continues with the create sale item record 850.

The post sale offer test 835 determines whether the auction seller wants to post a sale offer for one of the wanted item records displayed by the matching wanted items test 830. If the auction seller wants to post a sale offer, the user interface method 800 continues with the receive sale offer data step 840, otherwise the user interface method 800 ends 899.

The receive offer data step 840 obtains data from the auction seller concerning the offer to be made for a wanted item. In some embodiments, the receive offer data step 840 is initiated by the auction seller selecting a user interface element such as an icon, a control, a menu item, or the like. In some embodiments, the receive offer data step 840 includes registering the auction trader or logging the auction trader into the auction system. The receive offer data step 840 may ask the auction seller to verify the accuracy of data entered. The receive offer data step 840 may obtain offer data using a data entry page, a form, a dialog, a wizard, or the like.

The enter offer in database step 845 records the sale offer entered by the auction seller into the auction database 115. The enter offer in database step 845 may generate an email message to notify the auction buyer who created the wanted item record that an offer has been made on the wanted item. The enter offer in database step 845 may generate an email message to notify the auction seller that a sale offer has been entered into the auction database 115 using the auction seller's account. When the enter sale offer in database step 845 is completed, the user interface method 800 ends 899.

The create sale item record step 850 obtains data from an auction seller concerning an item to be offered for sale in the auction system. FIG. 11A is a flow chart diagram with the steps of an embodiment of the matching wanted items test 830 and create sale item record step 850 in greater detail. The create sale item record step 850 may be initiated by the auction seller selecting a user interface element such as a control, dialog, icon, hyperlink, or the like, or the create sale item record step 850 may be initiated when the matching wanted items test 830 does not return any wanted item records matching the search parameters entered by the auction seller. The create sale item record step 850 may obtain data using a data entry page, a form, a dialog, a wizard, or the like. When the create sale item record step 850 is completed, the user interface method 800 ends 899.

The display buyer page step 860 provides user interface elements that facilitate auction buyers searching the auction database 115 for sale item records and creating item-wanted records in the auction database 115. In some embodiments, the display buyer page step 860 includes registering the auction trader or logging the auction trader into the auction system.

The buyer activity test 865 determines whether the auction buyer is searching the auction database 115 for sale item records or listing wanted items. If the auction buyer is searching the auction database 115 for sale item records, the user interface method 800 continues with the matching sale items test 870; if the auction buyer is listing wanted items, the user interface method 800 continues with the create wanted item record step 890.

The matching sale items test 870 obtains search parameters from the auction buyer, searches the auction database 115 for records matching the search parameters, and presents the search results to the auction buyer. Search results may be presented as a list of sale item titles with links to pages with a detailed display of data associated with the sale item. FIG. 11B is a flow chart diagram with the steps of an embodiment of the matching sale items test 870 and create sale item record step 890 in greater detail. If the auction database 115 contains records that match the search parameters entered by the auction buyer, the user interface method 800 continues with the post bid test 875, otherwise the user interface method 800 continues with the create item-wanted record 890.

The post bid test 875 determines whether the auction buyer wants to post a bid for one of the sale item records displayed by the matching sale items test 870. If the auction buyer wants to post a bid, the user interface method 800 continues with the receive bid data step 880, otherwise the user interface method 800 ends 899.

The receive bid data step 880 obtains data from the auction buyer concerning the bid to be made for a sale item. In some embodiments, the receive bid data step 880 is initiated by the auction buyer selecting a user interface element such as an icon, a control, a menu item, or the like. In some embodiments, the receive bid data step 880 includes registering the auction trader or logging the auction trader into the auction system. The receive bid data step 880 may ask the auction buyer to verify the accuracy of data entered. The receive bid data step 880 may validate the data entered by the auction buyer by assuring that the bid entered exceeds the current bid by a required amount. The receive offer data step 840 may obtain offer data using a data entry page, a form, a dialog, a wizard, or the like.

The enter bid data in database step 885 records the bid entered by the auction seller into the auction database 115. The enter bid in database step 885 may generate an email message to notify the auction seller who created the sale item record that a bid has been made on the sale item. The enter bid in database step 885 may generate an email message to notify the auction buyer that a bid has been entered into the auction database 115 using the auction buyer's account. When the enter bid in database step 885 is completed, the user interface method 800 ends 899.

The create item-wanted record step 890 obtains data from an auction buyer concerning an item-wanted to be purchased through the auction system. FIG. 11B is a flow chart diagram with the steps of an embodiment of the matching sale items test 870 and create item-wanted record step 890 in greater detail. The create item-wanted record step 890 may be initiated by the auction buyer selecting a user interface element such as a control, dialog, icon, hyperlink, or the like, or the create item-wanted record step 890 may be initiated when the matching sale items test 870 does not return any sale item records matching the search parameters entered by the auction buyer. The create wanted item record step 890 may obtain data using a data entry page, a form, a dialog, a wizard, or the like. When the create item-wanted record step 890 is completed, the user interface method 800 ends 899.

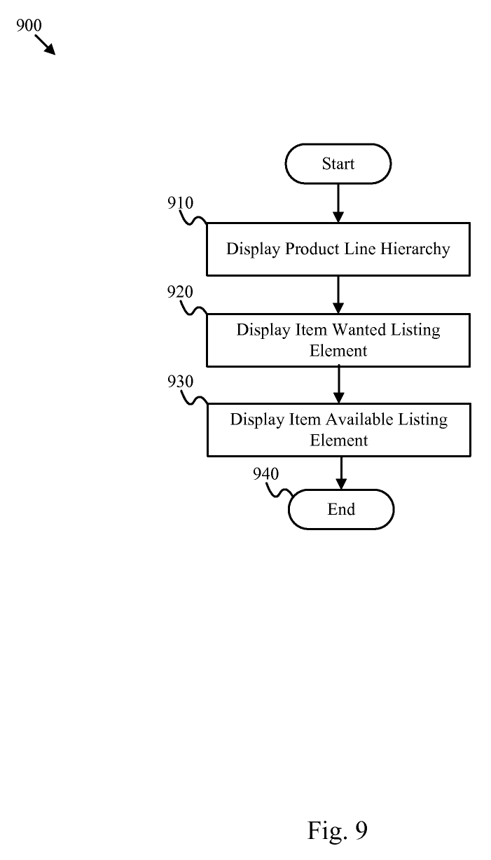

FIG. 9 is a flow chart diagram illustrating one embodiment of a customer request method 900 of the present invention. The customer request method 900 includes a display product hierarchy step 910, a display item-wanted element step 920, and a display item available element step 930. The customer request method 900 facilitates an auction buyer creating an item-wanted record in the auction database 115 that identifies a product in an auction seller's product line that the auction buyer wants to purchase, or requesting a new product to be added to the auction seller's product line. The customer request method 900 also facilitates an auction seller creating a sale item record in the auction database 115 that offers a new or used item in an auction seller's product line for purchase by other auction traders.

The display product hierarchy step 910 displays products in an auction seller's product line. Products may be displayed using user interface elements such as icons, text strings containing product names, tree components, or the like.

The display item-wanted element step 920 displays a user interface element that facilitates an auction buyer creating an item-wanted record in the auction database 115. The user interface element may be linked to a data entry page, a form, a dialog, a wizard, or the like. The item-wanted record may correspond to an existing product in the auction seller's product line hierarchy that is not available for sale, for example, if the product is not in stock by the auction seller. The item-wanted record may also correspond to a product that does not yet exist in the auction seller's product line, which the auction buyer is requesting to be added to the product line.

The display item available element step 930 displays a user interface element that facilitates an auction seller creating a sale item record in the auction database 115. The user interface element may be linked to a data entry page, a form, a dialog, a wizard, or the like. The sale item record may correspond to a new or used product from the product line hierarchy that the auction seller is offering for auction or immediate-sale.

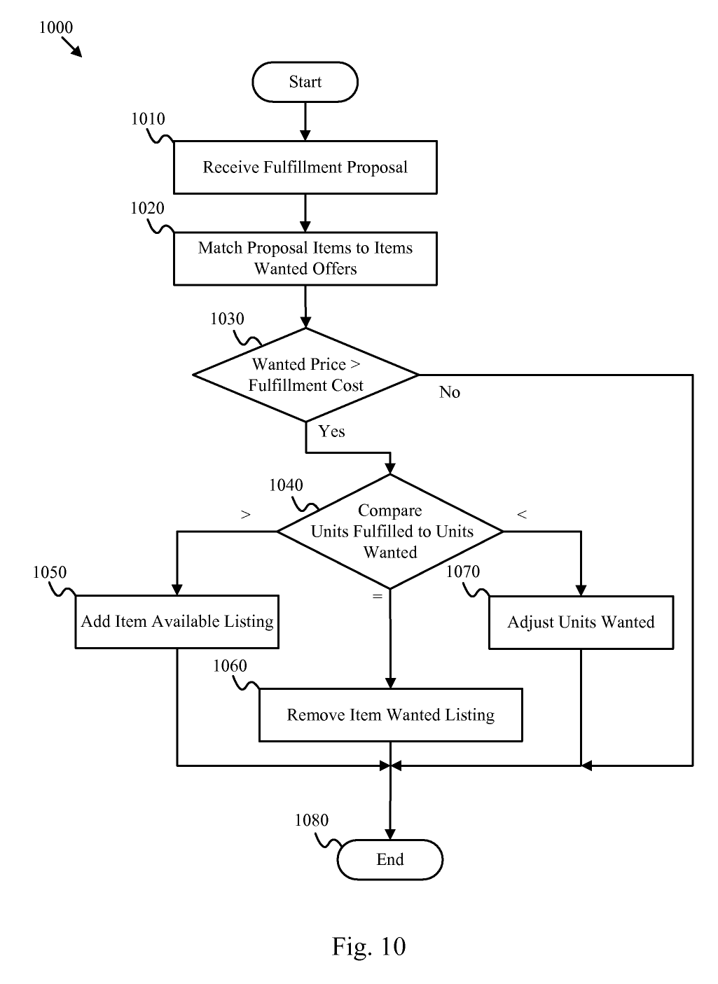

FIG. 10 is a flow chart diagram illustrating one embodiment of a proposal fulfillment method 1000 of the present invention. The proposal fulfillment method 1000 includes a receive proposal step 1010, a match proposal items to offers step 1020, a price greater than cost test 1030, a compare fulfilled to wanted test 1040, an add item available step 1050, a remove item-wanted step 1060, and an adjust units wanted step 1070. The proposal fulfillment method 1000 facilitates an auction buyer purchasing a plurality of related items at or below a specified price.

The receive proposal step 1010 receives a fulfillment proposal from an auction seller. A fulfillment proposal is type of sale offer wherein a number of identical items or numbers of related items are offered for sale at prices specified by the auction seller.

The match proposal items to offers step 1020 matches items in a fulfillment proposal to items wanted offers posted by the auction seller. The match proposal items to offers step 1020 may use specifications provided by the auction buyer to enumerate a set of product features or tolerances that will/be accepted in fulfilling the auction buyer's item-wanted listings.

The price greater than cost test 1030 determines whether the prices in the auction buyer's item-wanted offers are greater than the item costs in the fulfillment proposal. If the prices in the items wanted offers are greater than the item costs in the fulfillment proposal, the proposal fulfillment method 1000 continues with the compare fulfilled to wanted test 1040, otherwise the proposal fulfillment method 1000 ends 1080.

The compare fulfilled to wanted test 1040 compares the number of units of each item in the fulfillment proposal with the number of units of each item in the auction buyer's items wanted offers. The compare fulfilled to wanted test 1040 may use rules provided by the auction buyer to determine when a number of units of various items will be accepted for purchase. For example, an auction buyer may specify that up to 1000 computer CPUs will be purchased, but only if the fulfillment proposal includes a number of computer monitors equal to the number of CPUs. If the number of units fulfilled is greater than the number of units wanted, the proposal fulfillment method 1000 continues with the add item available listing step 1050. If the number of units fulfilled is equal to the number of units wanted, the proposal fulfillment method 1000 continues with the remove item-wanted listing 1060. If the number of units fulfilled is less than the number of units wanted, the proposal fulfillment method 1000 continues with the adjust units wanted step 1070.

The add item available step 1050 removes an item-wanted listing and creates a sale item listing in the auction database 115 for one of the items in the fulfillment proposal. The add item available step 1050 only executes when the auction buyer agrees to purchase more than the number of units wanted of one or more items in a set of item-wanted offers. For example, an auction buyer may have an item-wanted listing for 1000 computer CPUs, but agrees that up to 1200 CPUs will be purchased if a fulfillment proposal includes computer monitors for each CPU.

The remove item-wanted step 1060 removes an item-wanted listing from the auction database 115. The remove item-wanted step 1060 occurs when a fulfillment proposal supplies the exact number of items in an auction buyer's item-wanted listing.

The adjust units wanted step 1070 reduces the number of items wanted in the auction buyer's item-wanted listing by the number of items offered in an auction seller's fulfillment proposal. The item-wanted listing remains in the auction database 115, but the number of items in the item-wanted listing is reduced.

FIG. 11A is a flow chart diagram illustrating one embodiment of an item-wanted search method 1100 of the present invention. The item-wanted search method 1100 includes a display search items wanted page step 1110, a matching wanted items test 1115, a display matching wanted items step 1120, a display sell items page step 1125, a receive sell item data step 1130, an enter item record in database step 1135. The item-wanted search method 1100 facilitates an auction seller determining whether an auction buyer has posted an item-wanted listing for an item the auction seller has available for sale.

The display search items wanted page step 1110 obtains search parameters from the auction seller specifying attributes of items wanted records to search for in the auction database 115. The parameters searched for may include immediate-purchase items, best-offer purchase items, time-dependent pricing items, new items, or used items.

The matching wanted items test 1115 determines whether items wanted listings in the auction database 115 match the parameters provided by the auction seller. If the items wanted search parameters match any records in the auction database 115, the item-wanted search method 1100 continues with the display matching wanted step 1120, otherwise it continues with the display sell item page step 1125.

The display matching wanted items step 1120 displays the items wanted listings that match the search parameters provided by the auction seller. When the display matching wanted items step 1120 is completed, the item-wanted search method 1100 ends 1140.

The display sell items page step 1125 requests data from the auction seller concerning a sale item to be entered into the auction database 115. The display sell items page step 1125 may obtain data using a data entry page, a form, a dialog, a wizard, or the like.

The receive sell item data step 1130 obtains data from the auction seller corresponding to a sale item to be entered into the auction database 115. The receive sell item data step 1130 may ask the auction seller to verify the accuracy of data entered.

The enter item record in database step 1135 creates a new sale item record in the action database 115. The enter item record in database step 1135 may generate an email message to notify the auction seller that a sale offer has been entered into the auction database 115 using the auction seller's account. When the enter item record in database step 1135 is completed, the item-wanted search method 1100 ends 1140.

FIG. 11B is a flow chart diagram illustrating one embodiment of an auction item search method 1150 of the present invention. The auction item search method 1150 includes a display search sale items page step 1160, a matching sale items test 1165, a display matching sale items step 1170, a display item-wanted page step 1175, a receive item-wanted data step 1180, and an enter item-wanted in database step 1185.

The display search sale items page step 1160 obtains search parameters from the auction buyer specifying attributes of sale item records to search for in the auction database 115. The parameters searched for may include immediate-sale items, best-offer sale items, time-dependent pricing items, new items, or used items.

The matching sale items test 1165 determines whether items wanted listings in the auction database 115 match the parameters provided by the auction buyer. If the sale items search parameters match any records in the auction database 115, the auction item search method 1150 continues with the display matching sale items step 1170, otherwise it continues with the display item-wanted page step 1175.

The display matching sale items step 1170 displays the sale items listings that match the search parameters provided by the auction buyer. When the display matching sale items step 1170 is completed, the item-wanted search method 800 ends 1190.

The display item-wanted page step 1175 requests data from the auction buyer concerning an item-wanted to be entered into the auction database 115. The display item-wanted page step 1175 may obtain data using a data entry page, a form, a dialog, a wizard, or the like.

The receive item-wanted data step 1180 obtains data from the auction buyer corresponding to an item-wanted to be entered into the auction database 115. The receive item-wanted data step 1180 may ask the auction buyer to verify the accuracy of data entered.

The enter item-wanted in database step 1185 creates a new item-wanted record in the action database 115. The enter item-wanted in database step 1185 may generate an email message to notify the auction buyer that an item-wanted record has been entered into the auction database 115 using the auction buyer's account. When the enter item-wanted in database step 1185 is completed, the item-wanted search method 1100 ends 1190.

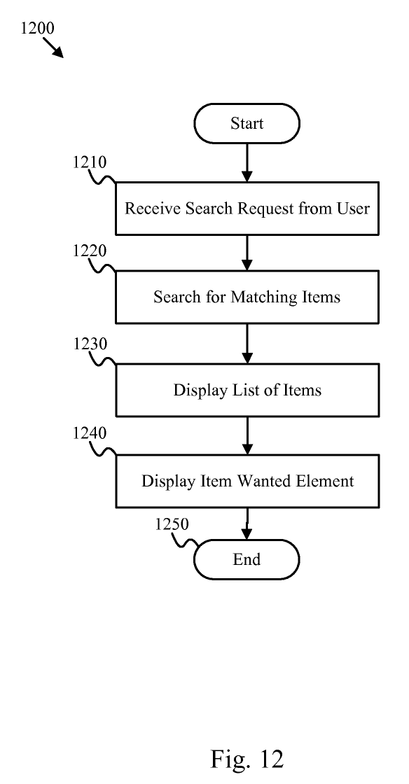

FIG. 12 is a flow chart diagram illustrating one embodiment of an item-wanted solicitation method 1200 of the present invention. The item-wanted solicitation method 1200 includes a receive search request step 1210, a search items step 1220, a display items step 1230, and a display item-wanted element step 1240. The item-wanted solicitation method 1200 facilitates an auction buyer creating an item-wanted listing based on an existing sale item listing, item-wanted listing, or search results listing. For example, after a search of the auction database 115 returns search results including an 1879 Morgan silver dollar, an auction buyer may create an item-wanted listing for an 1880 Morgan silver dollar.

The receive search request step 1210 obtains search parameters from the auction buyer specifying attributes of item records to search for in the auction database 115. The parameters searched for may include items wanted, immediate-sale items, best-offer sale items, time-dependent pricing items, new items, or used items. In another embodiment, the receive search request step 1210 may comprise browsing records in the auction database 115 rather than searching.

The search items step 1220 displays the item listings that match the search parameters provided by the auction buyer. The case where a search returns no matching items is not portrayed in the figure. In another embodiment, the search items step 1220 comprises browsing records in the auction database 115 rather than searching.

The display items step 1230 displays the item listings that match the search parameters provided by the auction buyer. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display item-wanted element step 1240 provides an auction buyer with the option of listing an auction item-wanted listing by displaying a user interface element such as a control, dialog, icon, hyperlink, or the like. The item-wanted element may be linked to a data entry page, a form, a dialog, a wizard, or the like. The item-wanted element may give the auction buyer the option of creating a new item-wanted record or creating an item-wanted record based on an existing sale item listing, item-wanted listing, or search results listing. When the display item-wanted element step 1240 is completed, the item-wanted solicitation method ends 1250.

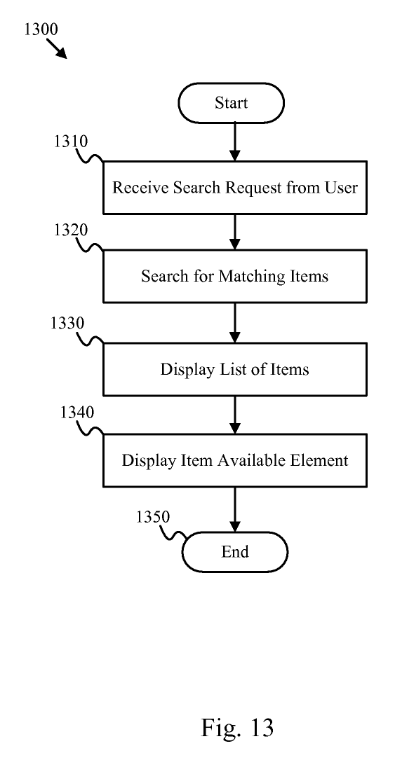

FIG. 13 is a flow chart diagram illustrating one embodiment of an item-available listing solicitation method 1300 of the present invention. The item-available listing solicitation method 1300 includes a receive search request step 1310, a search items step 1320, a display list step 1330, and a display item available element step 1340. The item available solicitation method 1300 facilitates an auction seller creating a sale item listing based on an existing sale item listing, item-wanted listing, or search results listing. For example, after a search of the auction database 115 returns search results including an item-wanted listing for an 1879 Morgan silver dollar, an auction seller may create a sale item listing for an 1880 Morgan silver dollar.

The receive search request step 1310 obtains search parameters from the auction seller specifying attributes of item records to search for in the auction database 115. The parameters searched for may include items wanted, immediate-sale items, best-offer sale items, time-dependent pricing items, new items, or used items. In another embodiment, the receive search request step 1310 may comprise browsing records in the auction database 115 rather than searching.

The search items step 1320 displays the item listings that match the search parameters provided by the auction seller. The case where a search returns no matching items is not portrayed in the figure. In another embodiment, the search items step 1320 comprises browsing records in the auction database 115 rather than searching.

The display list step 1330 displays the item listings that match the search parameters provided by the auction buyer. The items may be displayed in chronological order by the date and time they were posted, in chronological order by the auction end date and time, in numerical order by current bid, or in reverse numerical order by current bid. The display order and the auction item data fields displayed may be configurable by the auction trader.

The display item available element step 1340 provides an auction seller with the option of listing a sale item listing by displaying a user interface element such as a control, dialog, icon, hyperlink, or the like. The item available element may be linked to a data entry page, a form, a dialog, a wizard, or the like. The item available element may give the auction seller the option of creating a new sale item record or creating a sale item record based on an existing sale item listing, item-wanted listing, or search results listing. When the display item available element step 1340 is completed, the item-wanted solicitation method ends 1350.

FIG. 14 is a flow chart diagram illustrating one embodiment of an item-available to item-wanted link method 1400 of the present invention. The item-available to item-wanted link method 1400 includes a display item available offer step 1410, a link to item-wanted test 1420, and a create link step 1430. The item-available to item-wanted link method 1400 establishes a relationship between a sale item record and an item-wanted record in the auction database 115. The relationship may be established by an auction trader or a database process.

The display item available offer step 1410 displays a sale item record in the auction database 115. In some embodiments, the display item available offer step 1410 may provide the results of a search of the auction database 115 to a linking process.

The link to item-wanted test 1420 determines whether an auction trader or linking process is to establish a relationship between the sale item record displayed by the display item available offer step 1410 and an item-wanted record. If the auction trader or linking process is to establish a relationship, the item-available to item-wanted link method 1400 continues with the create link step 1430, otherwise the item-available to item-wanted link method 1400 ends 1440.

The create link step 1430 creates a relationship between the sale item displayed by the display item available offer step 1410 and the item-wanted record. The create link step 1430 may display a link to an item-wanted listing proximate to the sale item listing. After the create link step 1430 is completed, the item-available to item-wanted link method 1400 ends 1440.

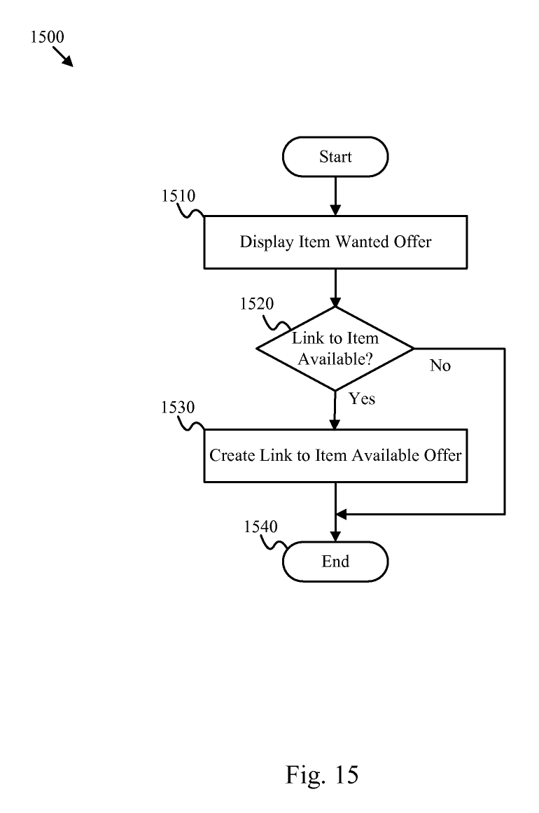

FIG. 15 is a flow chart diagram illustrating one embodiment of an item-wanted to item-available link method 1500 of the present invention. The item-wanted to item-available link method 1500 includes a display offer step 1510, a link to item available test 1520, and a display link step 1530. The item-wanted to item-available link method 1500 establishes a relationship between an item-wanted record and a sale item record in the auction database 115. The relationship may be established by an auction trader or a database process.

The display offer step 1510 displays an item-wanted record in the auction database 115. In some embodiments, the display item-wanted offer step 1510 may provide the results of a search of the auction database 115 to a linking process.

The link to item available test 1520 determines whether an auction trader or linking process is to establish a relationship between the item-wanted record displayed by the display offer step 1510 and a sale item record. If the auction trader or linking process is to establish a relationship, the item-wanted to item-available link method 1500 continues with the create link step 1530, otherwise the item-wanted to item-available link method 1500 ends 1540.

The create link step 1530 creates a relationship between the item-wanted displayed by the display offer step 1510 and the sale item record. The create link step 1530 may display a link to a sale item listing proximate to the item-wanted listing. After the create link step 1530 is completed, the item-wanted to item-available link method 1500 ends 1540.

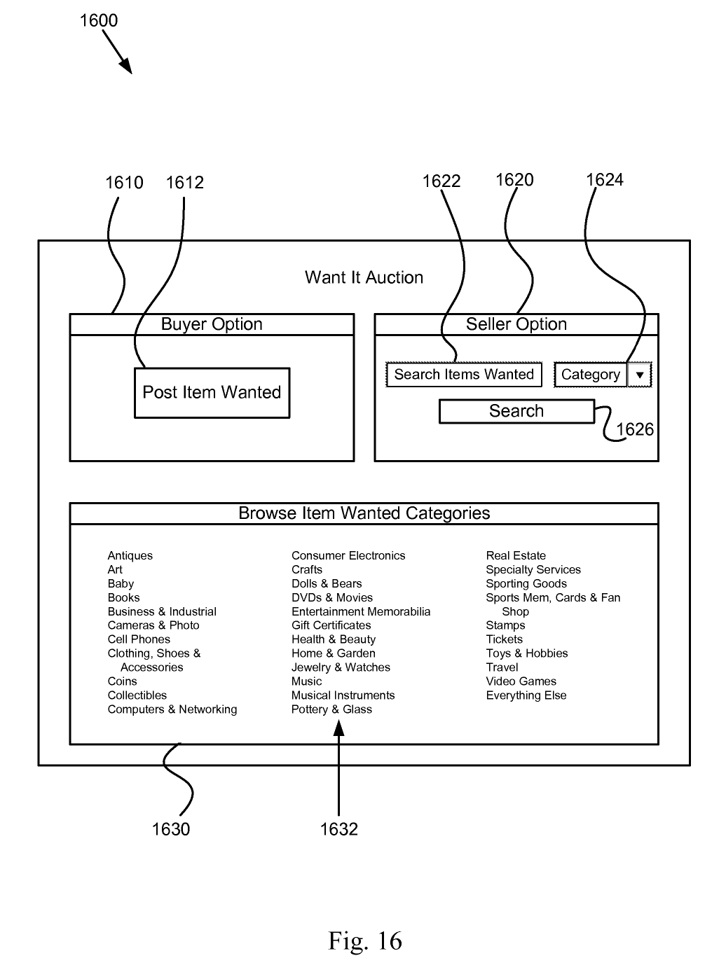

FIG. 16 is a block diagram illustrating one embodiment of an item-wanted initial dialog 1600 of the present invention. The item-wanted initial dialog 1600 includes a buyer panel 1610, a post item wanted control 1612, a seller panel 1620, a search item-wanted field 1622, a category selector 1624, a search item-wanted control 1626, a category panel 1630, and an individual link to each item-wanted category 1632. The item-wanted initial dialog 1600 facilitates auction traders navigating among item-wanted listings in the auction database 115.

The buyer panel 1610 comprises a navigation resource for auction traders wishing to add an item-wanted listing in the auction database 115. In the depicted embodiment, the buyer panel 1610 comprises a control 1612 for an auction trader to post an item wanted listing. The buyer panel 1610 may provide the auction trader with information to facilitate the process of posting an item-wanted listing. Such information may include a statement that there is no charge to post an item-wanted listing.

Seller panel 1620 comprises navigation resources for auction traders wishing to sell a possession matching an item-wanted listing in the auction database 115. In the depicted embodiment, the seller panel 1620 comprises a search item-wanted field 1622, a category selector 1624, and a search item-wanted control 1626. The seller panel 1620 may provide the auction trader with information to facilitate the process of searching for items wanted among the item-wanted listings. Such information may include a statement regarding specific versus non-specific search queries or narrowing a search by using the category selector 1624.

The search item-wanted field 1622 receives an auction trader's search query. In the depicted embodiment, the search query may include Boolean logic operators. In another embodiment, the search query may include natural language or a combination of Boolean logic and natural language and the auction trader may have the option of using Boolean logic operators or natural language queries, or a combination of Boolean logic operators and natural language.

The category selector 1624 may provide the auction trader with every defined category in the auction. In one embodiment, the category selector 1624 provides the auction trader with only categories populated with current item-wanted listings. In the depicted embodiment, the auction trader is allowed to select only one category to search. In another embodiment, the auction trader is allowed to select multiple categories to search. The search item-wanted control 1626 submits the auction trader's search query and category for item-wanted listing matches in the auction database 115.

The category panel 1630 may include individual links to each item-wanted category 1632 for auction traders wishing to browse individual categories of the item-wanted auction. In one embodiment, every defined category in the item-wanted auction database 115 is displayed. In another embodiment, only item-wanted categories populated with a current item-wanted listing in the item-wanted database 115 are displayed. In the depicted embodiment, the individual links to each item-wanted category 1632 enables the auction trader to navigate to a selected category and facilitates a selected category search 1800.

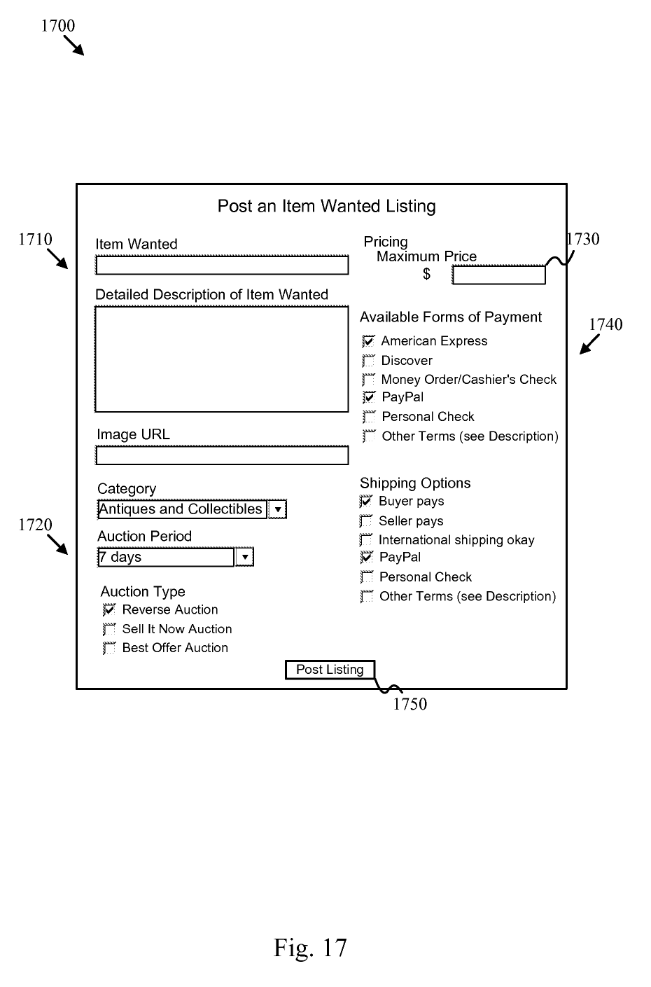

FIG. 17 is a block diagram illustrating one embodiment of an item-wanted listing dialog 1700 of the present invention. The item-wanted listing dialog 1700 includes auction description fields 1710, auction parameters elements 1720, a pricing element 1730, payment and shipping option elements 1740, and a post item control 1750. The item-wanted listing dialog 1700 facilitates auction traders listing item-wanted listings in the auction database 115.

Auction description fields 1710 receive information describing the item the auction buyer would like to purchase. The depicted fields include an auction title, a description of the item-wanted, a URL for the location of an image file containing a picture of the item-wanted, and a category for the item-wanted listing.

Auction parameters elements 1720 allow the auction seller to specify information about the auction. The depicted fields in the auction parameters elements 1720 include the length of the auction, and a definition of the auction type, reverse-auction, sell now auction, best-offer auction, or the like.

The pricing element 1730 allows the auction seller to specify the maximum price the seller is willing to pay for the item-wanted. In one embodiment, the pricing element 1730 includes a text field where the auction buyer may enter a description of items the buyer is willing to accept in trade.

Payment and shipping option elements 1740 facilitate the auction buyer specifying what methods of payment the buyer has available for payment and acceptable methods of shipping. In one embodiment, payment and shipping option elements 1740 include separate shipping options for domestic and international shipping.

The post item control 1750 facilitates posting data entered by the auction buyer for entry into the auction database 115. In one embodiment, the item-wanted listing dialog 1700 is associated with a method for validating data entered by the auction buyer before the data is transmitted to the auction database 115. The method may be conducted by a Perl script, Java applet, Javascript program, Python program or the like.

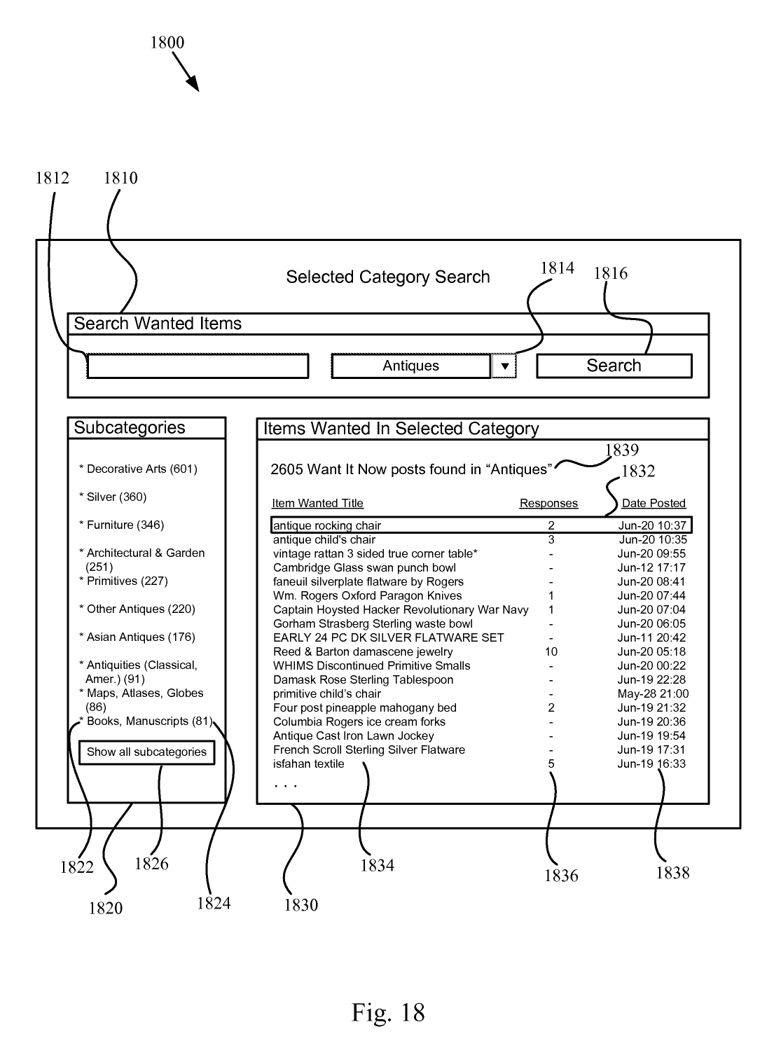

FIG. 18 is a block diagram illustrating one embodiment of a selected category search dialog 1800 of the present invention. The selected category search dialog 1800 includes a search wanted items panel 1810, a search field 1812, a category selector 1814, a search wanted items control 1816, a subcategory listing panel 1820, a subcategory title 1822, an item-wanted population indicator 1824, an items wanted listing panel 1830, an item-wanted listing 1832, an item-wanted title 1834, a responses indicator 1836, a date posted indicator 1838, and category information 1839. The selected category search dialog 1800 facilitates auction traders navigating through item-wanted listings stored on the auction database 115.

The search wanted items panel 1810 includes navigation resources for auction traders through item-wanted listings stored on the auction database 115. In the depicted embodiment, the search wanted items panel 1810 includes a search field 1812, a category selector 1814, and a search wanted items control 1816. The search wanted items panel 1810 may provide the auction trader with information to facilitate the process of searching for items wanted among the item-wanted listings. Such information may include text indicating either specific versus non-specific search queries or how to narrow a search by using the category selector 1814.

The search field 1812 receives an auction trader's search query. In one embodiment, the search query may use Boolean logic, natural language, or a combination of Boolean logic and natural language. The category selector 1814 may be pre-populated with the category selected from the item-wanted initial dialog 1600. The auction trader may select and search a new category by selecting the new category from the category selector 1814. The category selector 1814 may display every defined category in the auction to the auction trader.

In another embodiment, the category selector 1814 provides the auction trader with only categories populated with current item-wanted listings. In one embodiment, the auction trader selects only one category to search. In another embodiment, the auction trader selects multiple categories to search. The search wanted items control 1816 submits the auction trader's search query and category for item-wanted listing matches in the auction database 115.

The subcategory listing panel 1820 provides the auction trader with titles of subcategories of the selected category to facilitate further navigation. The subcategory listing panel 1820 includes a subcategory title 1822, an item-wanted population indicator 1824, and a subcategory control 1826. The subcategory title 1822 may display selectable subcategories of the category selected from the item-wanted initial dialog 1600. The amount of current item-wanted listings for each subcategory is displayed in the item-wanted population indicator 1824.

In one embodiment, every subcategory of the selected category is listed in the subcategory listing panel 1820. In another embodiment, only subcategories of the selected category containing item-wanted listings are displayed. In the depicted embodiment, selected subcategories that contain item-wanted listings are displayed. For example, the displayed subcategories may be selected for initial display based on popularity or amount of current item-wanted listings. In the depicted embodiment, all of the selected categories' subcategories containing item-wanted listings are displayed when subcategory control 1826 is activated.

When a subcategory is selected, the current item-wanted listings associated with the selected subcategory are displayed in the items wanted listing panel 1830 and subcategories of the selected subcategory are displayed in the subcategory listing panel 1820. The auction trader can perform this sequence by selecting a category or subcategory until the selected category or subcategory does not contain subcategories.

The items wanted listing panel 1830 may display category information 1839 regarding current item-wanted listings from the category selected in the initial item-wanted dialog 1600. Such category information 1839 may include the total number of current item-wanted listings and the title of the selected category. For example, the depicted category information 1839 reports two thousand six hundred and five (2605) current item-wanted listings within the “Antique” category, which is the depicted selected category. The items wanted listing panel 1830 lists any current item-wanted listing 1832 within the selected category. The item-wanted listing 1832 contains an item-wanted title 1834, a responses indicator 1836, and a date posted indicator 1838.

The item-wanted title 1834 displays the title of the item wanted. The highlighted item-wanted listing 1832 has a title of “antique rocking chair.” The responses indicator 1836 displays the amount of responses an item-wanted listing has received from auction traders. The highlighted item-wanted listing 1832 indicates that two (2) responses have been made by auction traders with potential matches for the item wanted. The date posted indicator 1838 indicates when the item-wanted listing was posted. The identified item-wanted listing 1832 indicates the listing was posted on June 20^{th} at 10:37. The depicted time information of the date posted indicator 1838 is 24-hour. The time may also be indicated by a 12-hour system with “a.m.” and “p.m.” indicators.

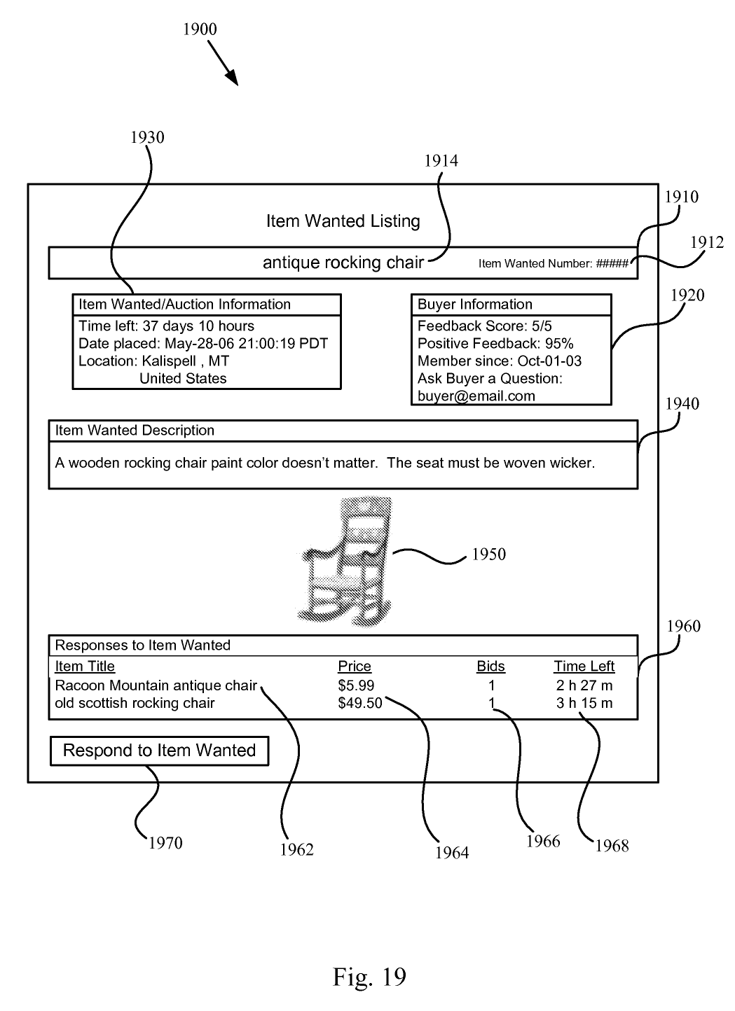

FIG. 19 is a block diagram illustrating one embodiment of an item-wanted listing 1900 of the present invention. As depicted, the item-wanted listing 1900 includes an item-wanted identification panel 1910, an item-wanted quantity 1912, an item-wanted title field 1914, a buyer information field 1920, an item-wanted auction information field 1930, an item-wanted descriptor 1940, an item-wanted image 1950, a responses module 1960, an item title 1962, a price 1964, a bids field 1966, a time field 1968, and a respond control 1970. The item-wanted listing 1900 facilitates auction traders responding to item-wanted listings and researching item-wanted listings on the auction database 115.

The item-wanted identification panel 1910 includes an item-wanted quantity 1912 and an item-wanted title field 1914. The item-wanted quantity 1912 displays an identifying number for the item-wanted listing 1900. The number may be the auction number or any other number to identify the item-wanted listing. The item-wanted title field 1914 displays the title of the item wanted. The depicted item-wanted listing 1900 has a title of “antique rocking chair.”

The buyer information field 1920 contains information regarding the buyer, who is the auction trader listing the item-wanted. Such information may include a feedback score earned by the buyer, a percentage of the feedback score that was positive, duration of buyer's membership, or an email link to ask a question to the buyer. The information is provided to notify auction traders of possible risks or benefits of trading with the buyer and to supply a method of contact to clarify discrepancies or questions the auction traders may have.

The item-wanted auction information field 1930 contains information regarding the auction. Such information may include the duration of the auction, the date and time the item-wanted listing was posted, and the location the item wanted will be shipped to. The item-wanted auction information may include a total number of responses received or a control to respond to the item-wanted listing 1900.

The item-wanted descriptor 1940 displays descriptive information regarding the item wanted by the buyer. In the depicted embodiment, the information and wording are provided by the buyer at item-wanted listing creation via the auction description field 1710 entitled “detailed description of item wanted.” The item-wanted image 1950 may be provided by the buyer to visually communicate characteristics about the item-wanted. In the depicted embodiment, one image is shown referencing the item-wanted listing. The image 1950 may contain multiple images provided by the buyer.

The responses module 1960 provides any auction trader with information regarding responses of auction items made to the item-wanted listing. The responses module 1960 includes an item title 1962, a price 1964, a bids field 1966, and a time field 1968. The item title 1962 provides the title of an item in an auction that another auction trader has responded to the item-wanted listing with.

The price 1964 provides the current price of the responding item. The price may be the current bid price of the auction or a non-negotiable, for sale price. The bids field 1966 indicates how many auction traders have bid on the responding item. If the responding item contains a non-negotiable, for sale price, the bids field 1966 may indicate such. The time field 1968 indicates the remaining time the responding item has in auction. The respond control 1970 facilitates auction traders responding to the item-wanted listing. The respond1970 control will navigate an auction trader to a response to item-wanted listing 2000.

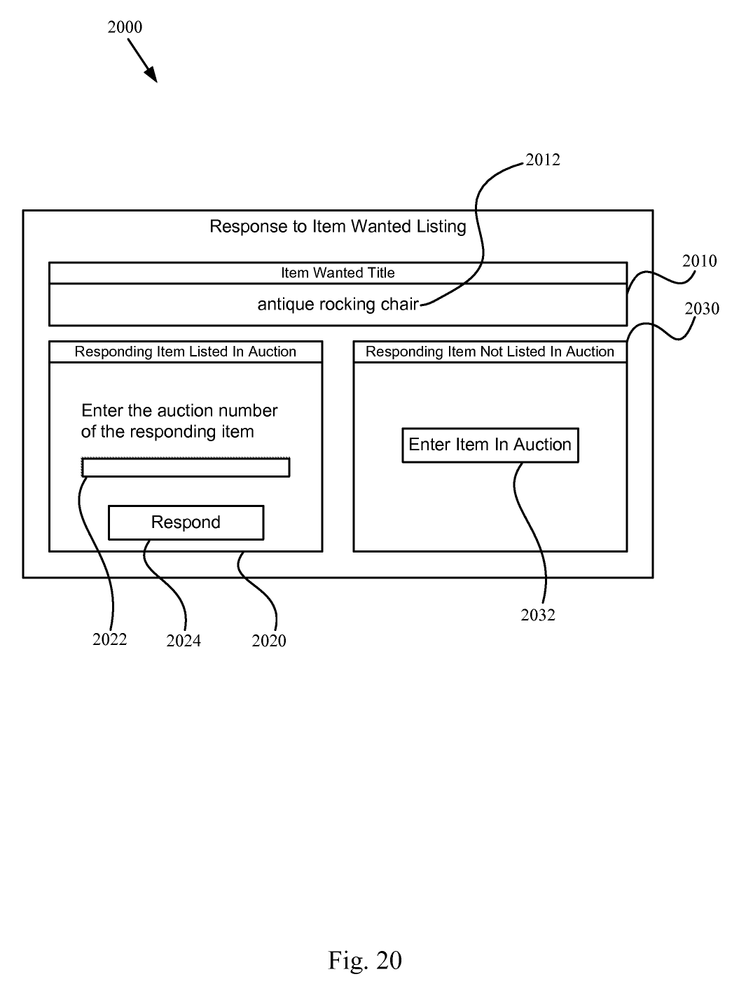

FIG. 20 is a block diagram illustrating one embodiment of a response dialog 2000 of the present invention. The response dialog 2000 includes an item-wanted identification panel 2010, an item-wanted title 2012, an in-auction response panel 2020, an auction number field 2022, a respond control 2024, a not-in-auction response panel 2030, and an enter auction control 2032. The response dialog 2000 facilitates auction traders responding to item-wanted listings.

The item-wanted identification panel 2010 provides information to the auction trader wishing to respond to an item-wanted listing. The depicted information is an item-wanted title 2012 which provides the title of the item wanted to the auction trader. Other information may be provided to the auction trader such as the item-wanted auction number 1912.

The in-auction response panel 2020 facilitates responding to an item-wanted listing when the responding item is currently listed in a participating auction. The in-auction response panel 2020 includes an auction number field 2022 and a respond control 2024. The auction trader enters the auction number of the responding item into the auction number field 2022. Activation of the respond control 2024 associates the auction number from the auction number field 2022 to the responses module 1960 of the item-wanted listing 1900. Responding to an item-wanted listing also increments the responses indicator 1836 of the item-wanted listing panel 1830 of the selected category search 1800.

The not-in-auction response panel 2030 facilitates responding to an item-wanted listing when the responding item is not currently listed in a participating auction. The not in auction responding module includes an enter auction control 2032. When the auction trader desires to respond to an item-wanted listing with an item not in a participating auction, the auction trader must enter the item in a participating auction. The enter auction control 2032 will provide the auction trader with a form to enter an item in a participating auction. Once the auction trader has completed and submitted the form, the responding item is assigned an auction identifier and associated with the item-wanted listing 1900 with fields updated similarly as accomplished via the in-auction response panel 2020.

The present invention facilitates online auction trading. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a user interface module programmed to host a site on the Internet;
a database;
the user interface module further programmed to receive through the site first information corresponding to an item wanted for purchase by a buyer and store the first information in the database;
the user interface module further programmed to receive through the site second information corresponding to an item available for purchase from a seller and store the second information in the database;
the user interface module further programmed to provide an interface control that enables a user to link the first information with the second information; and
the user interface module programmed to link the first information with the second information within the database in response to a user activating the interface control that enables a user to link the first information with the second information.

2. The system of claim 1, wherein the user interface module is further programmed to communicate selected portions of the second information to the buyer by sending an electronic mail message.

3. The system of claim 1, wherein the user interface module is further programmed to present at least one search control configured to facilitate locating an item wanted for purchase.

4. The system of claim 3, wherein the user interface module is further programmed to present a category selector configured to constrain a search of the database to item-wanted listings associated with a selected category.

5. The system of claim 1, wherein the user interface module is further programmed to present a post similar item control, the post similar item control configured to enable a user to post information describing an item available for purchase that is similar to an item wanted for purchase.

6. The system of claim 1, wherein the database is configured to store item-wanted postings.

7. The system of claim 1, wherein the user interface module is further programmed to list an item offered for sale in response to locating an item wanted for purchase.

8. The system of claim 1, wherein the user interface module is further programmed to display similar items wanted for purchase concurrently with a selected item wanted for purchase.

9. A method comprising:
hosting a site on the Internet;
receiving through the site first information corresponding to an item wanted for purchase by a buyer and storing the first information in a database;
receiving through the site second information corresponding to an item available for purchase from a seller and storing the second information in the database;
providing an interface control that enables a user to link the first information with the second information in the database; and
linking the first information with the second information within the database in response to a user activating the interface control that enables a user to link the first information with the second information.

10. The method of claim 9, further comprising communicating selected portions of the second information to the buyer.

11. The method of claim 9, further comprising presenting at least one search control to a user, the at least one search control configured to facilitate locating an item wanted for purchase.

12. The method of claim 11, further comprising presenting a category selector to a user, the category selector configured to constrain a search of the database to item-wanted listings associated with a selected category.

13. The method of claim 9, further comprising presenting a post similar item control to a user, the post similar item control configured to enable a user to post information describing an item available for purchase that is similar to an item wanted for purchase.

14. The method of claim 9, further comprising storing item-wanted postings in the database.

15. The method of claim 9, further comprising listing an item offered for sale in response to locating an item wanted for purchase.

16. The method of claim 9, further comprising displaying similar items wanted for purchase concurrently with a selected item wanted for purchase.

17. An apparatus comprising:
a user interface module programmed to provide a user interface comprising:
an item-wanted title indicator configured to indicate a title of an item-wanted posting to a user,
an auction number field configured to enable a user to enter an auction number of an item available for purchase that may conform to the item-wanted posting,
a respond control configured to enable a user to associate the auction number of an item available for sale with the item wanted posting;
the user interface module further programmed to associate the auction number with the item wanted posting in an auction database in response to user activation of the respond control.
